(19) United States
(12) Patent Application Publication
(10) Pub. No.: US 2017/0085630 A1
(43) Pub. Date: Mar. 23, 2017

(54) SYSTEM AND METHOD FOR CONTROL TRAFFIC BALANCING IN IN-BAND SOFTWARE DEFINED NETWORKS

(71) Applicant: Futurewei Technologies, Inc., Plano, TX (US)

(72) Inventors: Min Luo, San Jose, CA (US); Shih-Chun Lin, Alpharetta, GA (US); Ian F. Akyildiz, Alpharetta, GA (US)

(21) Appl. No.: 14/861,829

(22) Filed: Sep. 22, 2015

(51) Int. Cl. H04L 29/08; H04L 12/771

(52) U.S. Cl. CPC H04L 67/1002; H04L 45/56

(57) ABSTRACT

An apparatus is configured to perform a method for in-band control traffic load balancing in a software defined network (SDN). The method includes generating one or more Markovian traffic statistics for one or more control traffic and data traffic statistics. The method also includes constructing a queueing network system based on the Markovian traffic statistics. The method further includes determining a control traffic load balancing problem based on the Markovian traffic statistics. In addition, the method includes solving the control traffic load balancing problem using one or more primal-dual update rules.

### TECHNICAL FIELD

The present disclosure relates generally to software defined networks, and more particularly, to a system and method for control traffic balancing in in-band software defined networks, where the control traffic shares and uses data channels typically used only for data traffic.

### BACKGROUND

OpenFlow is a communications protocol that gives access to the forwarding plane of a network switch or router over a network, particularly in software defined networks (SDNs). SDN-OpenFlow has been recognized as a next-generation networking paradigm in on-line and adaptive traffic engineering for overcoming challenges facing current network systems. As SDNs become more widely accepted and adopted in both core and data center networks, methods to utilize SDNs in current IP networks become important. The proper use of SDN technology could help significantly increase resource utilization, reduce management complexity, and reduce management cost.

### SUMMARY

According to one embodiment, there is provided a method for in-band control traffic load balancing in a software defined network. The method includes generating one or more traffic statistics for one or more control traffic and data traffic statistics. The method also includes constructing a queueing network system based on the traffic statistics. The method further includes determining a control traffic load balancing problem based on the traffic statistics. In addition, the method includes solving the control traffic load balancing problem using one or more primal-dual update rules.

According to another embodiment, there is provided an apparatus for in-band control traffic load balancing in a software defined network. The apparatus includes at least one memory and at least one processor coupled to the at least one memory. The at least one processor is configured to generate one or more traffic statistics for one or more control traffic and data traffic statistics, construct a queueing network system based on the traffic statistics, determine a control traffic load balancing problem based on the traffic statistics, and solve the control traffic load balancing problem using one or more primal-dual update rules.

According to yet another embodiment, there is provided a non-transitory computer readable medium embodying a computer program. The computer program includes computer readable program code for generating one or more traffic statistics for one or more control traffic and data traffic statistics, constructing a queueing network system based on the traffic statistics, determining a control traffic load balancing problem based on the traffic statistics, and solving the control traffic load balancing problem using one or more primal-dual update rules.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example network architecture of a software defined network (SDN) that utilizes OpenFlow;

FIG. 2 illustrates a traffic model of an example SDN according to this disclosure;

FIG. 3 illustrates an example method for control traffic balancing according to this disclosure;

FIGS. 4 and 5 illustrate an example of modeling a network using a Markovian model according to this disclosure;

FIG. 6 illustrates an example method for fast optimization solving using an example alternating direction method of multipliers (ADMM) algorithm, according to this disclosure;

FIG. 7 illustrates an example of the rapid convergence rate of primal-dual update rules according to this disclosure;

FIG. 8 illustrates a comparison of the disclosed load balancing algorithm with other solutions in an Internet2 OS3E network;

FIGS. 9 and 10 illustrate a comparison of the disclosed load balancing algorithm with other solutions in a SPRINT GIP backbone network topology of North America; and

FIG. 11 illustrates an example of a computing device that may implement the methods and teachings according to this disclosure.

### DETAILED DESCRIPTION

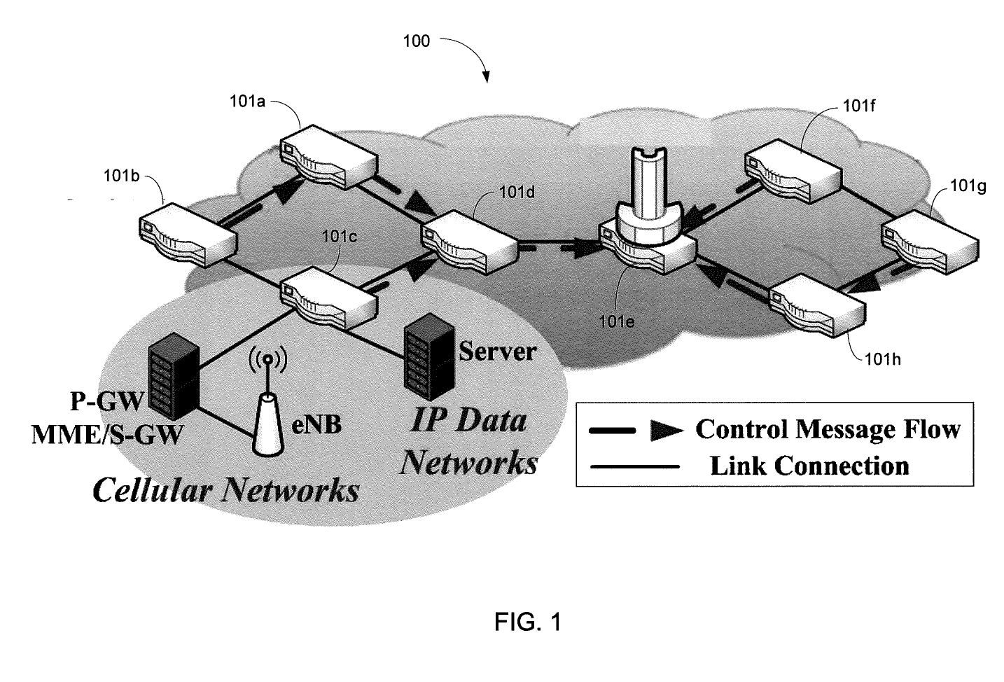

FIGS. 1 through 11, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example network architecture of a SDN that utilizes OpenFlow. As shown in FIG. 1, the SDN 100 includes a plurality of OpenFlow (OF) switches 101a-101h. While the SDN 100 is shown as including eight switches, other embodiments may include more or fewer switches. The switch 101e has been selected to serve as the controller for the SDN 100. Thus, the switch 101e makes routing decisions for the SDN 100. At least one switch 101c is in communication with other networks, including cellular networks or IP data networks, as shown in FIG. 1.

Load Balancing of In-Band Control Traffic in a SDN.

Typical SDNs, such as the SDN 100, decouple network forwarding infrastructure from the supporting management applications in order to provide on-line and adaptive traffic engineering. Unlike traditional IP networks (where the switch makes routing decisions), in a SDN, the switches do not make any routing decisions. Instead, the controller makes the routing decisions. For example, in FIG. 1, the switch 101e, acting as controller, makes all of the routing decisions for the SDN 100. In addition, multiple physically distributed controllers could be used for a large network. Embodiments of this disclosure will be described with respect to a single logical or physical controller case; however, it will be understood that this disclosure also encompasses SDNs with multiple controllers.

In a SDN with a centralized controller, there are two methods to communicate control information between the controller and the switch. These methods are typically categorized as in-band control and out-band control. In out-band control, every switch uses a separate control channel to communicate with the controller. Thus, the data band is generally not intermingled with the control channel. Out-band control was commonly used in prior networks. However, out-band control is cost-prohibitive for large-scale SDNs due to the required extra control channels.

In in-band control, the control signal and the data signal share the same channel. In-band control may be suitable for practical SDN implementations to provide timely delivery of control traffic from OF switches to the controller. However, there is currently no suitable solution for in-band controlled SDNs. In-band control is largely affected by the existing data traffic and the link serving capability. In an ideal SDN, the SDN controller (or controllers) would support the control functionality with a minimum network delay through the information of global network states and dynamic traffic statistics. However, in actual SDN implementations, network delay is often a significant issue due to large amounts of control traffic and data traffic overloading a link with a fixed serving capability.

One of the inherent issues of the in-band controller is how to utilize the same channel for both data forwarding and control. For example, the controller communicates instructions to the switch. Similarly, the switch reports congestion and other problems to the controller. The controller and switch utilize the same channel for these control communications and also for the data traffic. Priority of data traffic over the control communication can be critical. The challenge is to optimally balance the control traffic with the data traffic without significantly sacrificing the data traffic and providing sufficient priority to minimize delay.

A number of studies have examined issues of traffic balancing. However, most existing studies are focused on balancing data traffic in the data plane. These studies aim to evenly distribute data traffic flows among network links. In contrast, the objective of in-band control traffic balancing is to determine the control message forwarding paths of each switch in such a way that the control message delay is minimized, subject to both control and data traffic statistics, for timely delivery of control messages in the SDN. In-band control supports inter-availability between OF switch systems (i.e., SDNs) and non-OF switch systems (e.g., the Internet), without the heavy work of redeploying existing systems with a backward compatible design principle.

Thus, one issue related to in-band control in SDNs is the optimal control traffic forwarding problem: Given a controller location, find the optimal in-band forwarding paths between OF switches and the controller to minimize the average control traffic delay. Previously, there has been no suitable solution to this problem, which has limited the development of traffic management in SDNs.

To address this and other issues, embodiments of this disclosure provide a system and method to achieve good load balancing, efficient link utilization, and low queueing delay for concurrent control and data traffic in a centrally controlled SDN. The disclosed embodiments minimize the queueing latency of control traffic for in-band transmissions with existing data flows, thus providing high transmission quality. The disclosed embodiments are also highly scalable; they provide fast parallel computations to ensure low complexity for practical large system implementations. The disclosed embodiments achieve consistent good performance under a variety of traffic scenarios and different network topologies via traffic statistics driven designs.

The embodiments disclosed herein provide an innovative mechanism for control traffic balancing using a queueing network model and traffic statistics using, for example, a simplified Markovian traffic model. Some of the disclosed embodiments yield a fast convergence to the optimal solution by employing the Alternating Direction Method of Multipliers (ADMM). ADMM is a variant of the augmented Lagrangian scheme for solving constrained optimization problems. The disclosed embodiments provide a fast transmission methodology and real-time re-routing of control traffic without over-utilizing or minimizing the shared transmission bandwidth.

A SDN can be represented using a number of different models. Two kinds of models are a network graph model and a traffic model. Most networks (including SDNs) can be modeled as a set of nodes and a set of links connecting those nodes. Thus, one example of a network graph model of a SDN is G(V,J). Here, G represents a graph, which is an abstraction of the network. V represents a set of OF switches (i.e., nodes). In some models, n is used to represent the total number of switches. J represents a set of links connecting the n nodes.

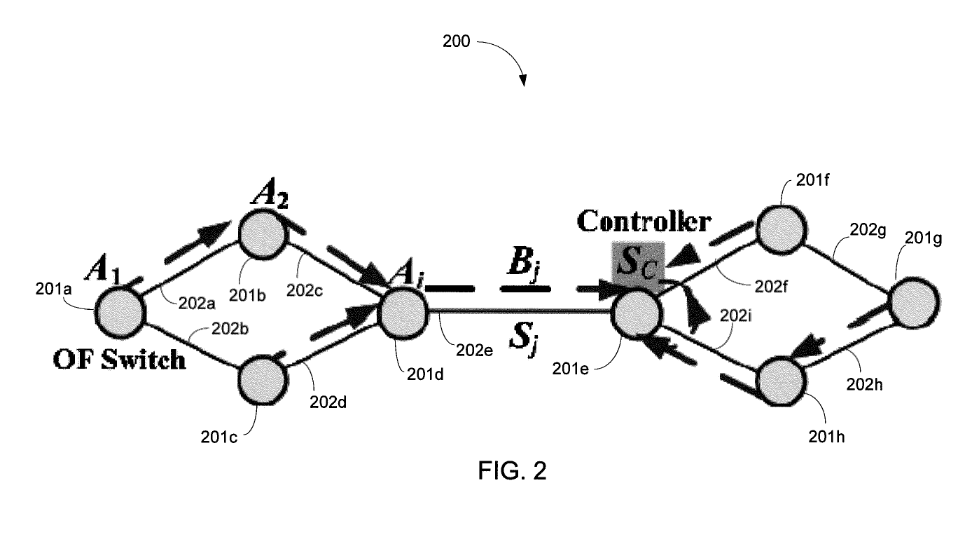

FIG. 2 illustrates a traffic model of an example SDN according to this disclosure. The traffic model 200 may represent a model of the SDN 100 of FIG. 1. As shown in FIG. 2, the SDN represented by the model 200 includes a plurality of nodes (i.e., switches) 201a-201h connected by a plurality of links 202a-202i. Although the traffic model 200 includes eight nodes and nine links, other embodiments could include more or fewer nodes or links. The controller of the SDN is at the node 201e. The traffic model 200 is a model of an incoming traffic arrival process. The traffic model 200 illustrates Markov traffic with a Markovian service process for both link transmission and the controller's serving capacity. As known in the art, Markov traffic is commonly accepted for Internet traffic modeling.

In the model 200, the control traffic of a switch i is modeled by a Poisson arrival process Aᵢ with mean σᵢ. The existing data flow of a link j is modeled by a Poisson arrival process Bⱼ with mean λⱼ. A link capacity of a link j is modeled by an exponential distributed process Sⱼ with mean 1/μⱼ. S_{c} represents the serving capacity of the serving controller of the SDN.

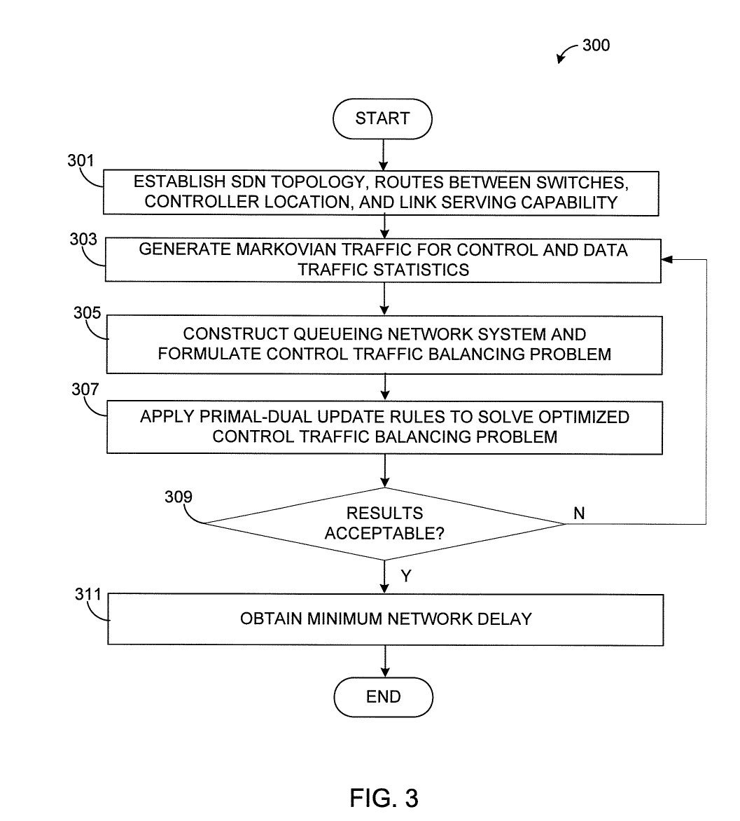

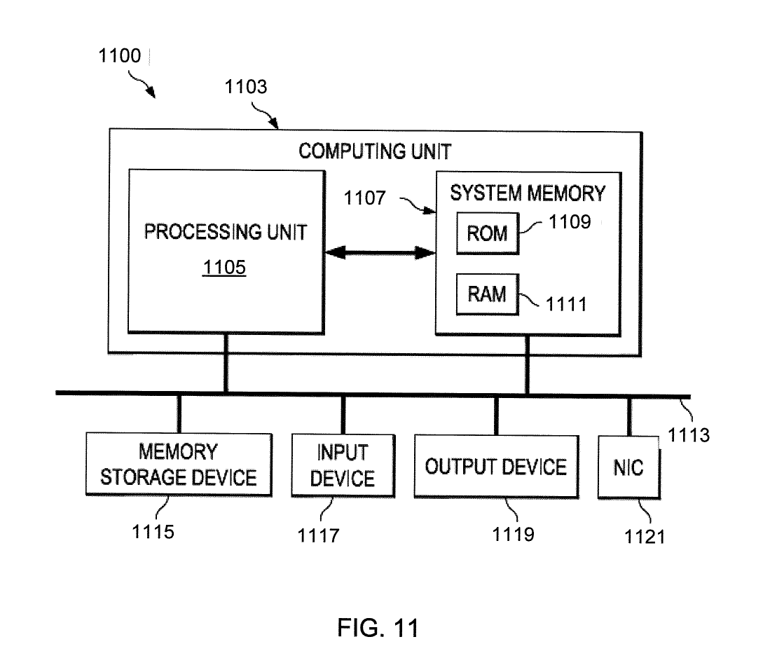

FIG. 3 illustrates an example method for control traffic balancing according to this disclosure. The method 300 shown in FIG. 3 is based on the key concepts described herein. The method 300 may be performed in association with the SDN 100 of FIG. 1 and the traffic model 200 of FIG. 2. The method 300 may be performed by the computing device 1100 of FIG. 11 described below. However, the method 300 could also be used with any other suitable device or system.

The method 300 starts at operation 301 in which a SDN topology, multi-path routes between OF switches, a controller location, and link serving capability are established. This may include the controller establishing topology matrices Tᵢ from each switch to itself via the global view of network topology.

To enable multi-path routing for control traffic balancing, the flow from a given switch i is characterized by a topology matrix Tᵢ of size |J∥Pᵢ|, which is given by the following:

$${T}_{i} [ j , p ] = \{ \begin{matrix}1 & If link j lies on path p \\ 0 & Otherwise\end{matrix}$$

where |Pᵢ| denotes the available paths for switch i. The topology matrices Tᵢ map the traffic from paths to links and should be full column-rank to avoid redundant paths. Such matrices can enable automatic route selection, instead of splitting control traffic among paths. Using these matrices, the flow conservation constraint is established for each switch's control traffic.

At operation 303, Markovian traffic statistics are generated for one or more control traffic and data traffic statistics, independent of link serving capability. This may include estimating traffic statistics based on the topology matrices Tᵢ. At operation 305, a queueing network system is constructed and an optimized control traffic load balancing problem is formulated based on the Markovian traffic statistics. Operations 303 and 305 represent a non-linear optimization framework, which is described in greater detail below. At operation 307, one or more primal-dual update rules are applied to solve the optimized control traffic load balancing problem formulated earlier in a fast and parallel manner. This may include the use of a fast optimization solving approach, also described in greater detail below.

At operation 309, it is determined if the results of the solved control traffic load balancing problem are acceptable. If it is determined that the results are not acceptable (e.g., if the fast optimization does not give a suitable result), the method 300 utilizes feedback adaptive control by returning to operation 303 for another possible controller location to fine tune the optimization problem formulation accordingly. Alternatively, if it is determined that the results are acceptable, then the method proceeds to operation 311.

At operation 311, the minimum network delay is obtained.

Although FIG. 3 illustrates one example of a method 300 for control traffic balancing, various changes may be made to FIG. 3. For example, while shown as a series of steps, various steps shown in FIG. 3 could overlap, occur in parallel, occur in a different order, or occur multiple times. Moreover, some steps could be combined or removed and additional steps could be added according to particular needs.

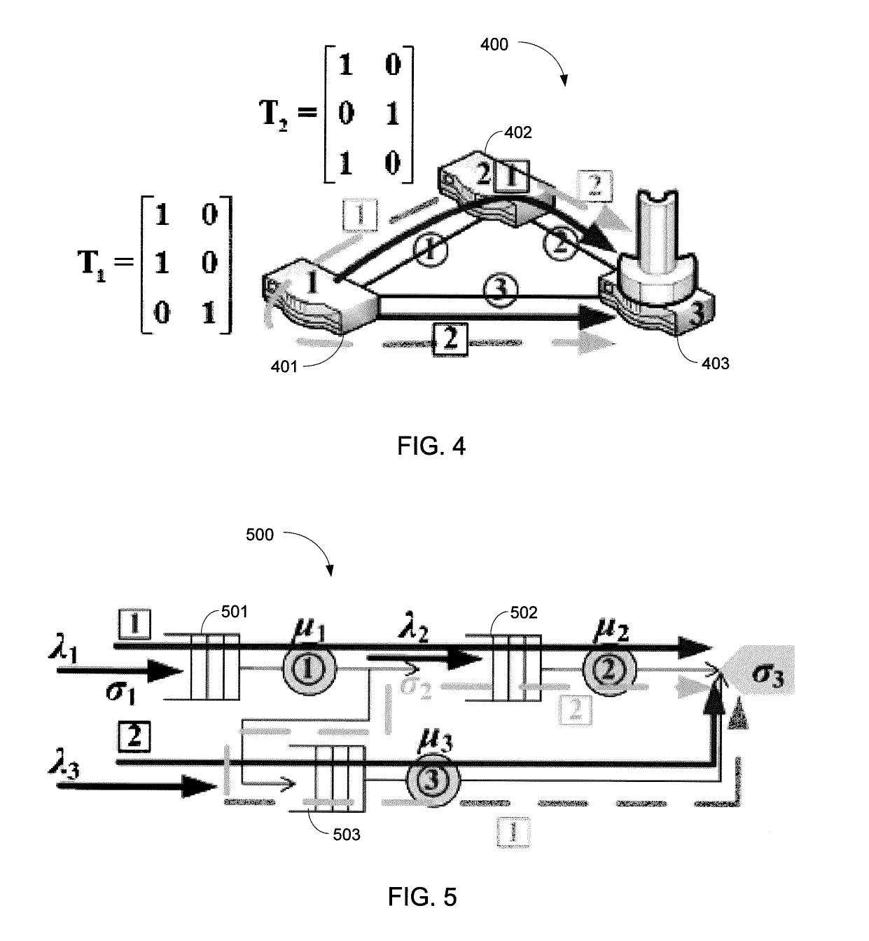

FIGS. 4 and 5 illustrate an example of modeling a network using a Markovian model according to this disclosure. FIG. 4 shows a network diagram representing a network 400 with one or more switches and controllers. FIG. 5 shows a queueing model of the network 400. FIGS. 4 and 5 illustrate example portions of the method 300 for control traffic balancing.

As shown in FIG. 4, the network 400 includes three OF switches 401-403. The switches 401-403 may represent various ones of the switches 101a-101h in FIG. 1 or the nodes 201a-201h in FIG. 2. In the network 400, the switch 403 is selected to be the controller. Although the network 400 includes three OF switches, other embodiments could include more or fewer switches. Two topology matrices T₁ and T₂, representing the topology matrices for the switches 401-402, are shown in FIG. 4.

The queueing model 500 in FIG. 5 uses a Markovian process to represent the incoming packet arrival process. The queueing model 500 includes three queues 501-503. The three queues 501-503 correspond to the three switches 401-403. Each queue has a pipeline. The value λᵢ is the average weight of the input into each queue. The value σᵢ represents a deviation, i.e., how variable is the incoming traffic. The value μᵢ also represents a weight.

Based on the system model and topology matrices, the disclosed embodiments provide a non-linear optimization framework to find the optimal control traffic assignment (i.e., load balancing) among links of the SDN. Such a non-linear optimization framework could be used in conjunction with the method 300 of FIG. 3. For example, the non-linear optimization framework could be used during operations 303 and 305 of the method 300. The optimization takes into consideration both data traffic and control traffic.

In general, to formulate a non-linear optimization, it is necessary to determine the objective and the constraints of the optimization. Here, the objective of the non-linear optimization is to minimize the average network delay.

The non-linear optimization is subject to a number of constraints. One constraint is flow conservation. For every input at a node, there is also an output. In some embodiments, the flow conservation constraint is associated with possible automatic route selection. A second constraint is link serving capacity. Each link has a maximum capacity that it is capable of processing. In general, a link cannot exceed this maximum capacity. A third constraint is a bandwidth guarantee of data traffic. In most networks, it is necessary to ensure that the control traffic does not interfere with the bandwidth guarantee for the data traffic.

It can be shown that the in-band control traffic load balancing problem is a NP-hard (Non-deterministic Polynomial-time hard) problem. In computational complexity theory, a NP-hard problem is a problem that is at least as hard as the hardest problems in non-deterministic polynomial-time. Accordingly, in some embodiments, a polynomial-time algorithm can be employed to yield an optimal solution to the problem with a pre-specified accuracy.

In accordance with this disclosure, a fast convergent algorithm (i.e., the algorithm converges very quickly) O(1/c^{m}) having primal-dual rules can be employed to enable fast transmission and real-time re-routing of control traffic. In some embodiments, the algorithm can be based on ADMM techniques. Of course, ADMM is merely one example; additionally or alternatively, the algorithm can be based on other methods.

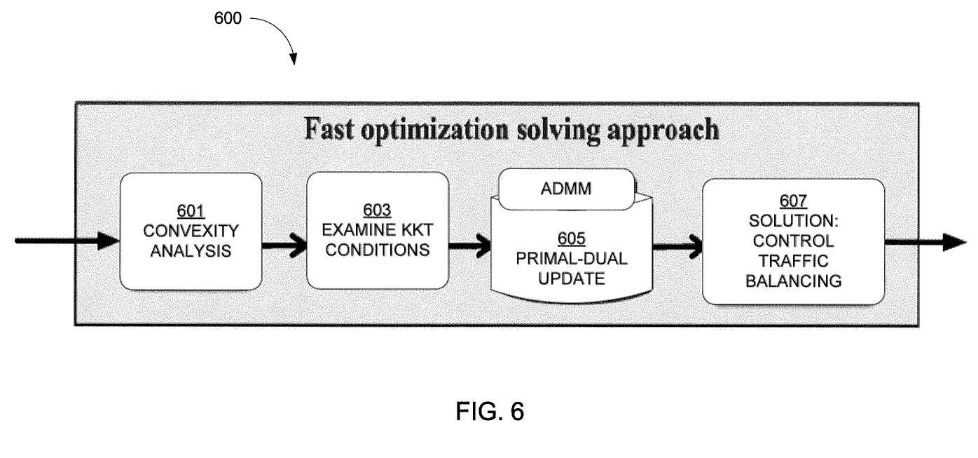

FIG. 6 illustrates an example method for fast optimization solving using an example ADMM algorithm, according to this disclosure. The method 600 may be performed in conjunction with the SDN 100 of FIG. 1 and the method 300 of FIG. 3. For example, one or more operations of the method 600 may represent one or more operations of the method 300. The method 600 may be performed by the computing device 1100 of FIG. 11 described below. However, the method 600 could also be used with any other suitable device or system.

In operations 601 and 603, the in-band control traffic load balancing problem is analyzed. Specifically, in operation 601, the convexity of the load balancing problem is analyzed with simplified Markovian traffic statistics. The statistics demonstrate that the load-balancing problem is strictly a convex problem. In particular, in the load-balancing problem, the local minimum coincides with the global minimum.

In operation 603, the Karush-Kuhn-Tucker (KKT) conditions of the load balancing problem are examined to prove the existence of the optimal solution for the convex load balancing problem. In general, optimal control traffic assignment is obtained by iteratively calculating the assignment with respect to each switch and each link. However, it may be difficult or impossible to get the optimal solution in a real-time manner for every link and switch in a large scale SDN. Such calculations would be much too slow. Instead, a fast numerical calculation can be used to obtain a sub-optimal, but still good, solution in each time iteration.

In operation 605, a fast iterative algorithm (e.g., an ADMM algorithm) is used to yield an optimal solution in a few iterations and provide a sub-optimal solution in each iteration. The ADMM algorithm includes primal-dual update rules. That is, the ADMM algorithm is executed alternatively between primal and dual problems (or variables). The ADMM algorithm converges to an optimal value in a few iterations. The algorithm can be stopped at any time to get a “good enough” solution for real-time applications.

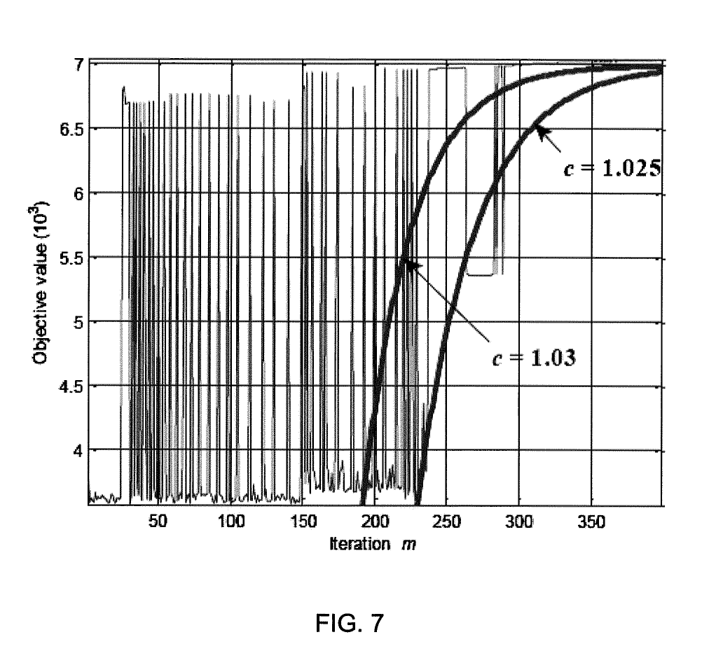

The fast global convergence of the primal-dual update rules can be proven. The primal-dual update rules converge to the optimal solutions with rate O(1/c^{m}) where c>1 is a constant and m is the number of iterations. For example, FIG. 7 illustrates one example of the rapid convergence rate of the primal-dual update rules. As shown in FIG. 7, for different values of c, the algorithm generates satisfactory values after approximately 300 iterations. In some embodiments, this may serve as a desired stopping point.

In operation 607, the non-linear load balancing problem is solved with the linear fast convergence algorithm. Accordingly, the optimal (or sub-optimal) control traffic assignments are obtained for real-time applications.

Although FIG. 6 illustrates one example of a method 600 for fast optimization solving, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs.

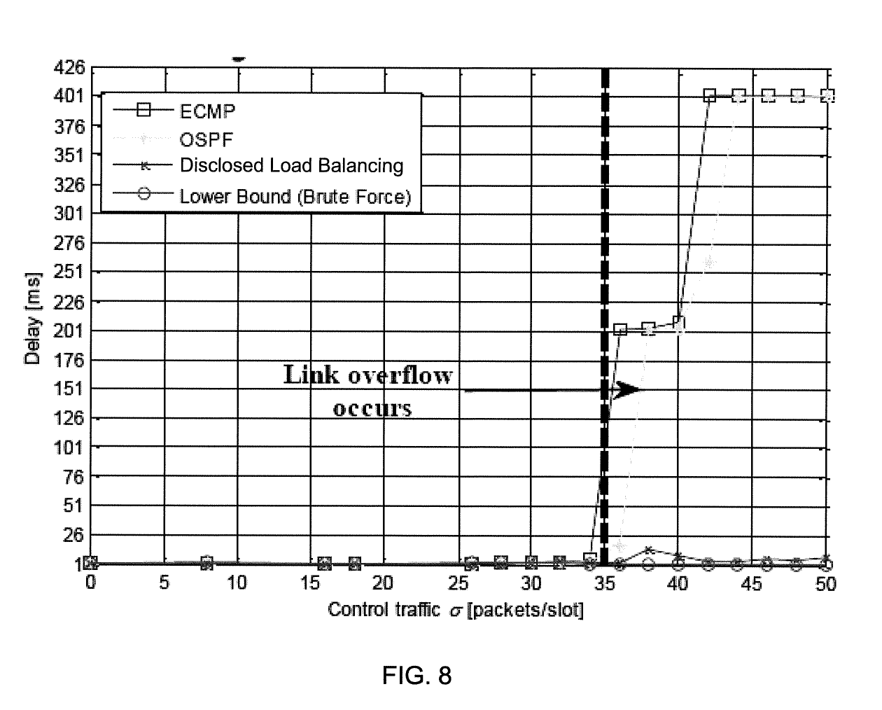

To demonstrate its effectiveness, the disclosed algorithm has been tested and compared with other solutions in various test environments. For example, FIG. 8 illustrates a comparison of the disclosed load balancing algorithm with other solutions in an Internet2 OS3E network (described in greater detail in Internet2, “Open Science, Scholarship and Services Exchange,” 2013, the contents of which are incorporated herein by reference). The Internet2 OS3E network includes 27 nodes and 36 links, and is widely used in the art for performance evaluation of controller placement problems and solutions.

In FIG. 8, the disclosed load balancing algorithm is compared with a lower bound (brute force) algorithm, an Open Shortest Path First (OSPF) solution, and an Equal Cost Multi-Path (ECMP) solution. The lower bound technique is a conventional technique that employs exhaustive searching to obtain the best feasible results for control traffic balancing. As known in the art, OSPF is a routing protocol for Internet Protocol (IP) networks. OSPF is a conventional scheme that utilizes a single shortest path for data transmissions. ECMP is a multi-path transmission scheme that utilizes multiple paths for equally split traffic.

The plots in FIG. 8 show the average network delay for control traffic for each method in the Internet2 OS3E Network. As shown in FIG. 8, both the OSPF and ECMP techniques result in dramatic delay increases due to link overflow when the control traffic rate increases. In contrast, the load balancing algorithm disclosed herein provides substantial delay reduction compared to OSPF and ECMP for heavy control traffic. In fact, the disclosed load balancing algorithm provides results close to the lower bound technique, without the heavy searching computations that are require for that technique.

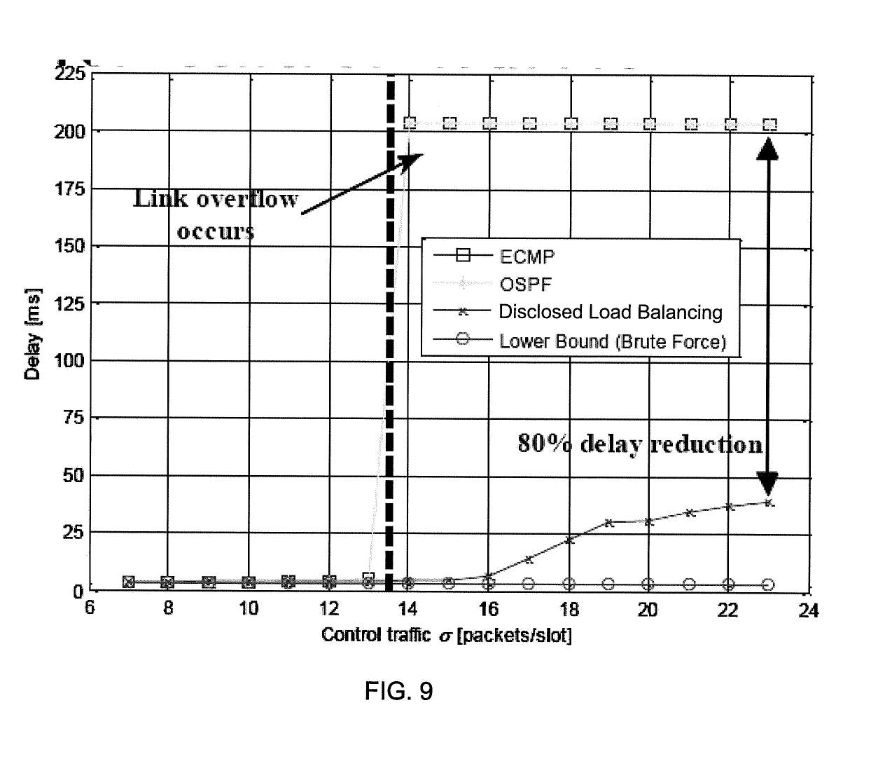

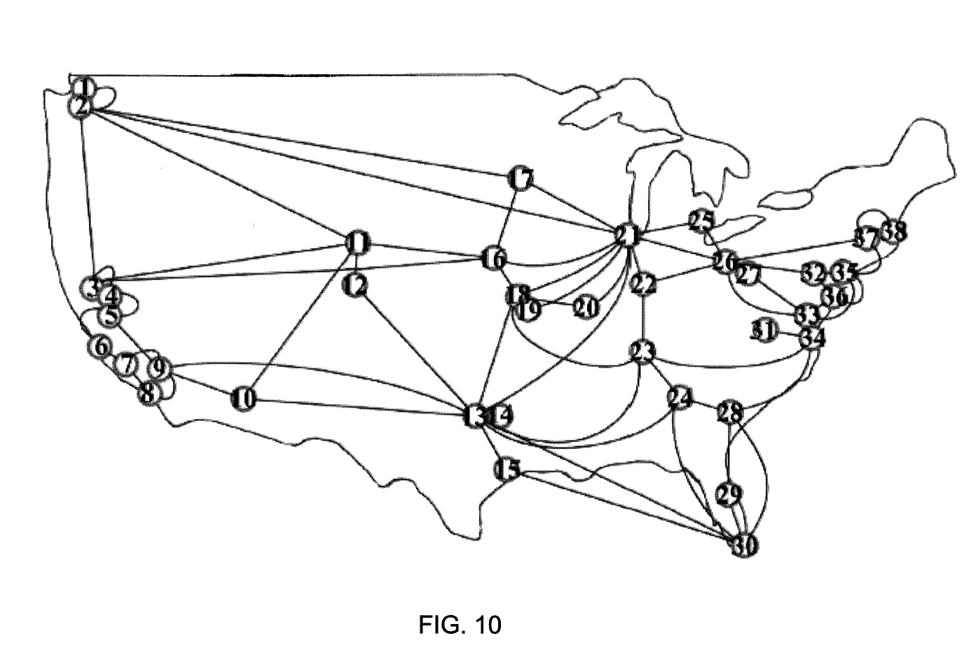

FIG. 9 illustrates a comparison of the disclosed load balancing algorithm with the lower bound (brute force) algorithm, the OSPF, and the ECMP solution in a SPRINT GIP backbone network topology of North America. Shown in FIG. 10, the SPRINT GIP backbone network topology of North America includes 38 nodes and 66 links across the United States. The network is a real network topology with actual link delay of data traffic. Such delay information is utilized to estimate the corresponding data traffic arrival and serving rates.

The plots in FIG. 9 show the average network delay for control traffic for each method in the SPRINT GIP network. As shown in FIG. 9, the OSPF and ECMP techniques again result in large delay increases due to link overflow when the control traffic rate increases. In contrast, the load balancing algorithm disclosed herein outperforms OSPF and ECMP with an 80% delay reduction and has a small delay compared to the lower bound technique for heavy control traffic.

FIG. 11 illustrates an example of a computing device 1100 that may implement the methods and teachings according to this disclosure. In particular, the computing device 1100 may perform the method 300 of FIG. 3 or the method 600 of FIG. 6 in the SDN 100 of FIG. 1.

As shown in FIG. 11, the computing device 1100 includes a computing block 1103 with a processing block 1105 and a system memory 1107. The processing block 1105 may be any type of programmable electronic device for executing software instructions, but will conventionally be one or more microprocessors. The system memory 1107 may include both a read-only memory (ROM) 1109 and a random access memory (RAM) 1111. As will be appreciated by those of skill in the art, both the read-only memory 1109 and the random access memory 1111 may store software instructions for execution by the processing block 1105.

The processing block 1105 and the system memory 1107 are connected, either directly or indirectly, through a bus 1113 or alternate communication structure, to one or more peripheral devices. For example, the processing block 1105 or the system memory 1107 may be directly or indirectly connected to one or more additional memory storage devices 1115. The memory storage devices 1115 may include, for example, a “hard” magnetic disk drive, a solid state disk drive, an optical disk drive, and a removable disk drive. The processing block 1105 and the system memory 1107 also may be directly or indirectly connected to one or more input devices 1117 and one or more output devices 1119. The input devices 1117 may include, for example, a keyboard, a pointing device (such as a mouse, touchpad, stylus, trackball, or joystick), a touch screen, a scanner, a camera, and a microphone. The output devices 1119 may include, for example, a display device, a printer and speakers. Such a display device may be configured to display video images. With various examples of the computing device 1101, one or more of the peripheral devices 1115-1119 may be internally housed with the computing block 1103. Alternately, one or more of the peripheral devices 1115-1119 may be external to the housing for the computing block 1103 and connected to the bus 1113 through, for example, a Universal Serial Bus (USB) connection or a digital visual interface (DVI) connection.

With some implementations, the computing block 1103 may also be directly or indirectly connected to one or more network interfaces cards (NIC) 1121, for communicating with other devices making up a network. The network interface cards 1121 translate data and control signals from the computing block 1103 into network messages according to one or more communication protocols, such as the transmission control protocol (TCP) and the Internet protocol (IP). Also, the network interface cards 1121 may employ any suitable connection agent (or combination of agents) for connecting to a network, including, for example, a wireless transceiver, a modem, or an Ethernet connection.

It should be appreciated that the computing device 1100 is illustrated as an example only, and it not intended to be limiting. Various embodiments of this disclosure may be implemented using one or more computing devices that include the components of the computing device 1100 illustrated in FIG. 11, or which include an alternate combination of components, including components that are not shown in FIG. 11. For example, various embodiments of the invention may be implemented using a multi-processor computer, a plurality of single and/or multiprocessor computers arranged into a network, or some combination of both.

As discussed above, control traffic balancing is an important consideration for configuration of in-band software defined networks. The disclosed embodiments provide a framework to consider the impact of control traffic separately from data traffic and link serving capability. These embodiments provide a method for fast re-routing of control traffic, and may serve as the foundation for designing traffic-aware controller architecture.

Various embodiments provide a linear-fast convergent algorithm that achieves an optimal solution in a few iterations, and provides a sub-optimal solution in each iteration for real-time application. The disclosed embodiments are applicable to generic large-scale SDNs with different traffic statistics due to the low computational and implementation complexities of the disclosed solutions.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for in-band control traffic load balancing in a software defined network (SDN), the method comprising:
generating one or more traffic statistics for one or more control traffic and data traffic statistics;
constructing a queueing network system based on the traffic statistics;
determining a control traffic load balancing problem based on the traffic statistics; and
solving the control traffic load balancing problem using one or more primal-dual update rules.

2. The method of claim 1, wherein the one or more traffic statistics comprise Markovian traffic statistics.

3. The method of claim 1, further comprising:
determining if a result of the solved problem is acceptable; and
upon a determination that the result of the solved problem is not acceptable, repeating the generating, constructing, determining, and solving operations.

4. The method of claim 3, wherein the generating, constructing, and determining operations comprise a portion of a non-linear optimization framework.

5. The method of claim 4, wherein solving the control traffic load balancing problem is based on alternating direction method of multipliers (ADMM) principles.

6. The method of claim 5, wherein solving the control traffic load balancing problem comprises:
analyzing a convexity of the control traffic load balancing problem;
analyzing the Karush-Kuhn-Tucker (KKT) conditions of the control traffic load balancing problem; and
using a fast iterative ADMM algorithm to yield a solution in a few iterations and provide a sub-optimal solution in each iteration.

7. An apparatus for in-band control traffic load balancing in a software defined network (SDN), the apparatus comprising:
at least one memory; and
at least one processor coupled to the at least one memory, the at least one processor configured to:
generate one or more traffic statistics for one or more control traffic and data traffic statistics;
construct a queueing network system based on the traffic statistics;
determine a control traffic load balancing problem based on the traffic statistics; and
solve the control traffic load balancing problem using one or more primal-dual update rules.

8. The apparatus of claim 7, wherein the one or more traffic statistics comprise Markovian traffic statistics.

9. The apparatus of claim 7, wherein the at least one processor is further configured to:
determine if a result of the solved problem is acceptable; and
upon a determination that the result of the solved problem is not acceptable, repeat the generate, construct, determine, and solve operations.

10. The apparatus of claim 9, wherein the generate, construct, and determine operations comprise a portion of a non-linear optimization framework.

11. The apparatus of claim 10, wherein the at least one processor is configured to solve the control traffic load balancing problem based on alternating direction method of multipliers (ADMM) principles.

12. The apparatus of claim 11, wherein to solve the control traffic load balancing problem, the at least one processor is configured to:
analyze a convexity of the control traffic load balancing problem;
analyze the Karush-Kuhn-Tucker (KKT) conditions of the control traffic load balancing problem; and
use a fast iterative ADMM algorithm to yield a solution in a few iterations and provide a sub-optimal solution in each iteration.

13. A non-transitory computer readable medium embodying a computer program, the computer program comprising computer readable program code for:
generating one or more traffic statistics for one or more control traffic and data traffic statistics;
constructing a queueing network system based on the traffic statistics;
determining a control traffic load balancing problem based on the traffic statistics; and
solving the control traffic load balancing problem using one or more primal-dual update rules.

14. The non-transitory computer readable medium of claim 13, wherein the one or more traffic statistics comprise Markovian traffic statistics.

15. The non-transitory computer readable medium of claim 13, the computer program further comprising computer readable program code for:
determining if a result of the solved problem is acceptable; and
upon a determination that the result of the solved problem is not acceptable, repeating the generating, constructing, determining, and solving operations.

16. The non-transitory computer readable medium of claim 15, wherein the generating, constructing, and determining operations comprise a portion of a non-linear optimization framework.

17. The non-transitory computer readable medium of claim 16, wherein solving the control traffic load balancing problem is based on alternating direction method of multipliers (ADMM) principles.

18. The non-transitory computer readable medium of claim 17, wherein solving the control traffic load balancing problem comprises:
analyzing a convexity of the control traffic load balancing problem;
analyzing the Karush-Kuhn-Tucker (KKT) conditions of the control traffic load balancing problem; and
using a fast iterative ADMM algorithm to yield a solution in a few iterations and provide a sub-optimal solution in each iteration.
